(19) United States
(12) Patent Application Publication
(10) Pub. No.: US 2016/0176657 A1
(43) Pub. Date: Jun. 23, 2016

(54) Coupling Point and Coupling Station for a Pneumatic Conveyance System for Conveying Bulk Material

(71) Applicant: Walter KRAMER, Hünenberg See (CH)

(72) Inventor: Walter Kramer, Hünenberg See (CH)

(21) Appl. No.: 14/908,689

(22) PCT Filed: Jul. 28, 2014
(86) PCT No.: PCT/EP2014/002057

§ 371 Date: Jan. 29, 2016

(30) Foreign Application Priority Data
Jul. 29, 2013 (DE) 10 2013 012 868.4

(51) Int. Cl. B65G 53/56; F16L 41/00; B65G 53/04

(52) U.S. Cl. CPC B65G 53/56; B65G 53/04; F16L 41/00

(57) ABSTRACT

The invention relates to a coupling point serving to form a coupling station between at least two senders and at least one receiver of a pneumatic conveyance system for conveying bulk material. The bulk material is directed by sender tubes and receiver tubes, which fluidically connect the sender and the receiver to the coupling station (6). The coupling point is a plug-in module which has at least one sender divider tube (7) and at least one receiver divider tuber (12). The sender divider tube (7) has at least one outlet (10) and the receiver divider tube (12) has at least one inlet (15) for the bulk material. The sender divider tube (7) and the receiver divider tube (12) each have at least one connection (9, 14) for a next plug-in module (21) or a sender tube (4) or receiver tube (5). The outlet (10) of the sender divider tube (7) and the inlet (15) of the receiver divider tube (12) can be closed or released. The coupling station has at least two dimensionally stable plug-in modules, each having at least one sender divider tube and at least one receiver divider tube which are fluidically connected or connectable to each other.

The invention concerns a coupling point for a pneumatic conveyance system for conveying bulk material according to the preamble of claim 1 as well as a coupling station for a pneumatic conveyance system for conveying bulk material according to the preamble of claim 17.

In regard to such conveyance systems with which bulk material, for example, granular plastic material, is pneumatically conveyed, it is known to supply the bulk material from several senders in the form of silos and the like through sender pipes, a coupling station, and receiver pipes in a targeted fashion to various receivers (for example, separating containers or processing machines). The coupling station enables supply of the respective bulk material to the respective receiver. The sender pipes of each sender are provided with a number of outlets that corresponds to the number of receivers. The receiver pipes are provided with sliding pipes that are moved in such a way that the respective outlet of the sender pipe is coupled with the receiver pipe of the selected receiver. The outlets which are not coupled with the sliding pipes must be closed. Such a coupling station is constructively very complex.

Also, coupling stations are known in which the sender pipes are arranged in a circle. Instead of a sliding pipe, a turntable is provided in this case that, by means of the appropriate rotary movement, connects fluidically the respective sender pipe with the desired receiver pipe. Such a coupling station is also of a very complex construction and accordingly expensive.

In regard to pneumatic conveyance systems coupling stations are known (DE 42 24 408 C1) in which the coupling station is provided with a slider plate. Each sender pipe is provided with a supply line in the form of a hose. These supply lines can be linked with the receiver pipes in that the hose ends which are located within the coupling station are moved on the slider plate such that the end of this line reaches a central connecting opening of the slider plate. The sender-associated lines as well as the receiver-associated lines are mandatorily embodied as hoses. When a malfunction occurs in such a coupling station, the entire conveyance system is inoperative.

Moreover, conveyance systems are known in which the sender pipes comprise a number of outlets which corresponds to the number of receivers. The receiver pipes are provided with flexible lines which are connected to the respective outlet of the corresponding sender. This system is also of a complex construction and prone to malfunction due to the flexible lines. The flexible lines must be manually adjusted in a complex way. In practice, these flexible lines often lead to them becoming entangled over the course of time.

The invention has the object to design the coupling point of the aforementioned kind and the coupling station of the aforementioned kind in such a way that in a constructively simple and inexpensive way the material to be conveyed is conveyed from the sender to the respective receiver without adjustment of conduit sections.

This object is solved for the coupling point of the aforementioned kind in accordance with the present invention with the characterizing features of claim 1 and for the coupling station of the aforementioned kind in accordance with the invention with the characterizing features of claim 17.

The coupling point according to the invention is characterized in that it is formed by a plug module that comprises at least one sender pipe part and at least one receiver pipe part. The sender pipe part is provided with the at least one outlet and the receiver pipe part with the at least one inlet for the bulk material. The sender pipe part and the receiver pipe part each are also provided with at least one connector. It enables connecting two or more plug modules with each other by means of these connectors or connecting the plug module with a sender pipe or a receiver pipe. In order to convey the bulk material from the sender to the respective receiver, an adjustment of conveying conduits is not required. By means of the connectors, several plug modules can be plugged together to a coupling station wherein the sender pipe parts and the receiver pipe parts of the plug modules are connected fixedly with each other. It is only required to open or close the outlet of the sender pipe part and the inlet of the receiver pipe part so that the bulk material can pass from the sender to the desired receiver. The plug module enables simple assembly of a coupling station. Since no mobile conduit parts are used, a constructively very simple configuration of a coupling station assembled of the plug modules according to the invention is provided.

The outlet of the sender pipe part and at least a portion of the inlet of the receiver pipe part of the plug module are positioned preferably oppositely slanted relative to each other such that the outlet in flow direction extends at a slant upwardly and the inlet in flow direction at a slant downwardly. In this way, it is achieved that the bulk material, should it accidentally reach a blocked outlet or inlet, can automatically return to the bulk material flow.

The outlet and the inlet are advantageously formed by a pipe section branching off a pipe section of the sender pipe part or of the receiver pipe part. In this way, the two pipe parts can be connected to each other very simply and stably.

The connectors are preferably provided on at least one end of the pipe sections of the sender pipe part and the receiver pipe part. In this way, the plug modules can be easily connected by means of these connectors to the pipe sections of the sender pipe parts or receiver pipe parts. In this way, a coupling station can be constructed very simply.

In an advantageous embodiment, the connectors are slidable coupling sleeves. They enable a simple plug connection between the individual plug modules. The coupling sleeves are preferably designed like clamp collars with which a medium-tight connection can be produced in a simple and reliable way.

In order for the plug module to have satisfactory shape stability and stiffness, the sender pipe part and the receiver pipe part are advantageously supported relative to each other by means of a support.

In an advantageous embodiment, the outlet of the sender pipe part and the inlet of the receiver pipe part are connected to each other for release by a connecting pipe. It is advantageous in this context that the connecting pipe is connected by a plug connection with the outlet and with the inlet. This enables a very simple manufacture of the plug module. In such a constructively simple configuration, the connecting pipe is designed to be removable. When no conveyance through the coupling point is to be performed, the connecting pipe is removed and the outlet of the sender pipe part as well as the inlet of the receiver pipe part are closed off by closures such as closure plugs or the like.

A simple connection of the connecting pipe results when it comprises a center part that is adjoined by pipe ends which extend in the same direction at a slant, preferably in the same plane. They can then be connected in a simple way to the slantedly upwardly extending outlet of the sender pipe part and the slantedly downwardly extending inlet of the receiver pipe part.

In the area of this connecting pipe, a closure device is preferably provided with which the passage through the connecting pipe can be opened or closed when the connecting pipe is provided on the plug module so as not to be removable. Since the closure device is located in the area of the connecting pipe, the bulk material is in contact with this closure device only when the connecting pipe is open. As long as the closure device closes off the connecting pipe, the bulk material is not guided through this connecting pipe during its transport to the receiver so that it also does not come into contact with this closure device. It is therefore only stressed minimally and has therefore a long service life.

The axes of the pipe sections of the sender pipe part and the receiver pipe part are positioned advantageously in different planes. This enables a very simple assembly of the plug module.

The planes are positioned preferably parallel to each other.

A very compact configuration of the plug module results when the spacing between these planes is corresponding at least approximately to the diameter of the pipe sections of the sender pipe part or receiver pipe part, preferably, to a multiple of this diameter.

The connecting pipes of the plug modules extend preferably at a slant relative to these planes. This contributes to a compact construction of the plug module as well as of the coupling station formed thereof.

Advantageously, the pipe sections of the sender pipe part and the receiver pipe part are positioned perpendicular to each other. This provides for easy assembly and configuration of the coupling station formed of such plug modules.

In order to provide that, in case that several receivers are connected simultaneously to the same sender and one of these receivers is subjected to vacuum, i.e., is conveying, no bulk material from the sender pipe reaches the receiver pipes that are connected to the sender and are not subjected to vacuum, the pipe configuration from the sender pipe part to the receiver pipe part is advantageously designed such that it has deflections whose deflection angle in total amounts to at least 270°. The bulk material is therefore deflected upon conveyance within this pipe configuration in total by at least 270°. Due to this strong deflection, no or only a minimal proportion of the bulk material will reach the receiver conduits connected to the same sender and not subjected to vacuum.

In a preferred embodiment, the inlet of the receiver pipe part is formed of pipe sections that are joined angularly to each other. Advantageously, these pipe sections are joined at a right angle relative to each other. With such an embodiment of the pipe configuration, it is possible without problems to also achieve large deflection angles that can for all intents and purposes amount to 360° and more. In this way, the bulk material guiding action in the area of the coupling point can be easily adapted to the application situation.

The coupling station according to the invention is characterized in that it comprises at least two shape-stable plug modules that each comprise at least a sender pipe part and at least a receiver pipe part that are connected or connectable to each other fluidically. The shape-stable plug modules result in a stable coupling station which has a simple configuration. In a preferred embodiment, the plug module has a sender pipe part and a receiver pipe part so that any individual coupling point can be produced in the coupling station. By means of the coupling station it is advantageously possible to supply the bulk material from a sender simultaneously to two or more receivers (parallel operation).

A plug module can also be designed, for example, such that it comprises two sender and two receiver pipe parts. In this case, in one plugging-in process two coupling points are formed. When, for example, two such plug modules are combined, then four coupling points are formed in the coupling station.

Since movable conduit parts are not present in the coupling station, a problem-free guiding action of the bulk material from the sender to the desired receiver is provided.

The subject matter of the invention not only results from the subject matter of the individual claims but also from all details and features disclosed in the drawings and in the description. Even if they are not subject matter of the claims, they are claimed as important to the invention inasmuch as they are novel relative to the prior art individually or in combination.

Further features of the invention result from the additional claims, the description, and the drawings.

The invention will be explained in more detail with the aid of some embodiments illustrated in the drawings. It is shown in:

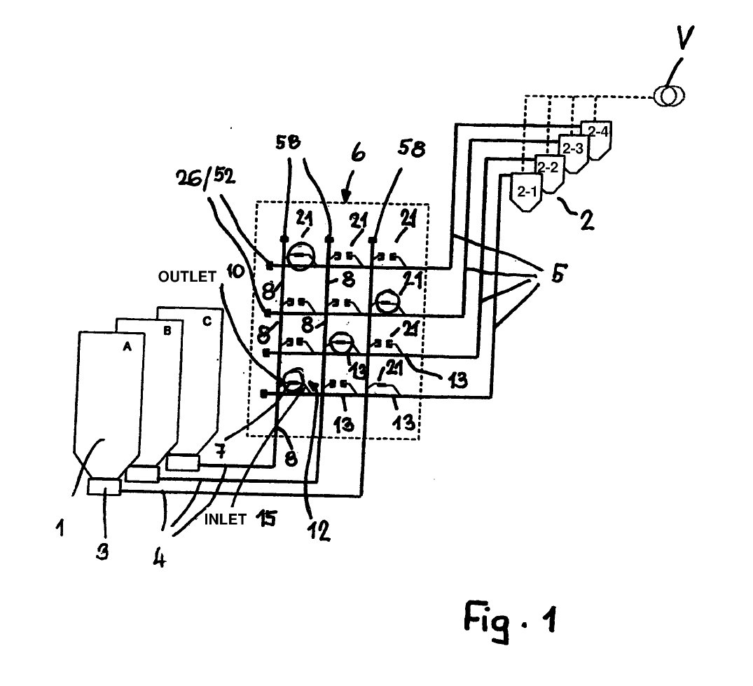

FIG. 1 in schematic illustration a vacuum conveyance system for transport of bulk material with a coupling station between senders and receivers that are connected by sender pipes and receiver pipes with the coupling station;

FIG. 2 in front view a coupling point of the coupling station according to the invention with a sender pipe part and a receiver pipe part;

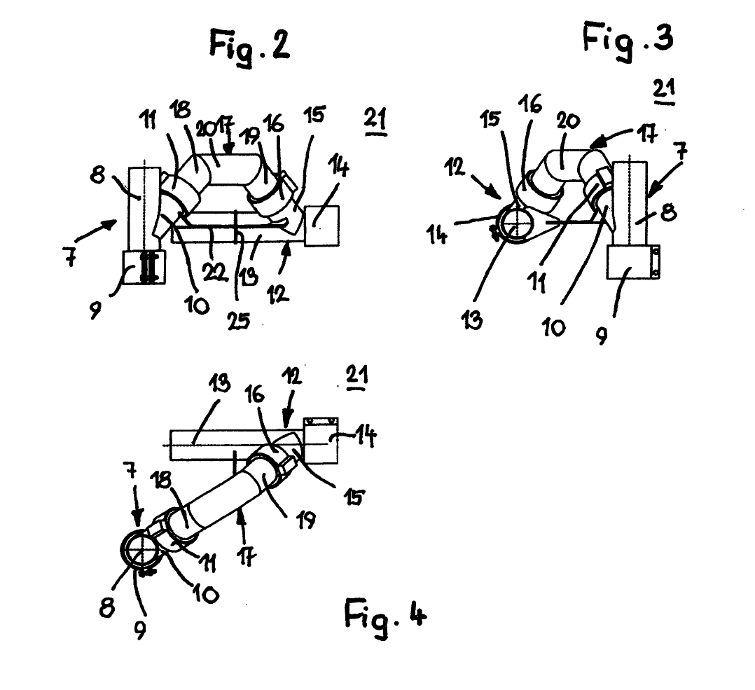

FIG. 3 the coupling point according to FIG. 2 in side view;

FIG. 4 the coupling point according to FIG. 2 in plan view;

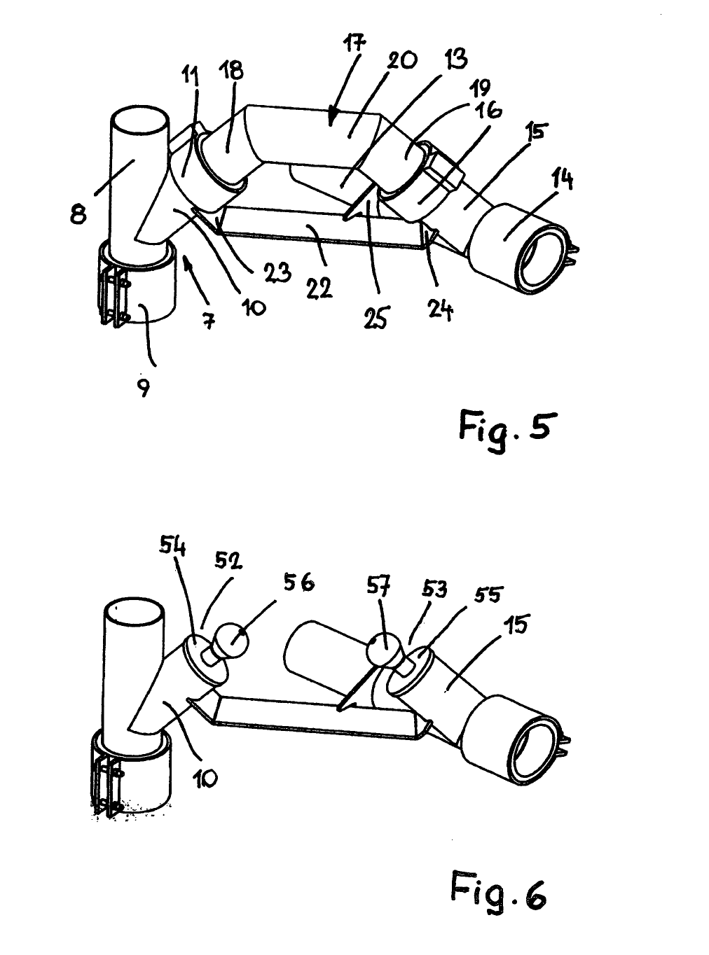

FIG. 5 the coupling point according to FIG. 2 in perspective illustration in the open state;

FIG. 6 the coupling point according to FIG. 5 in blocked state;

FIG. 7

to

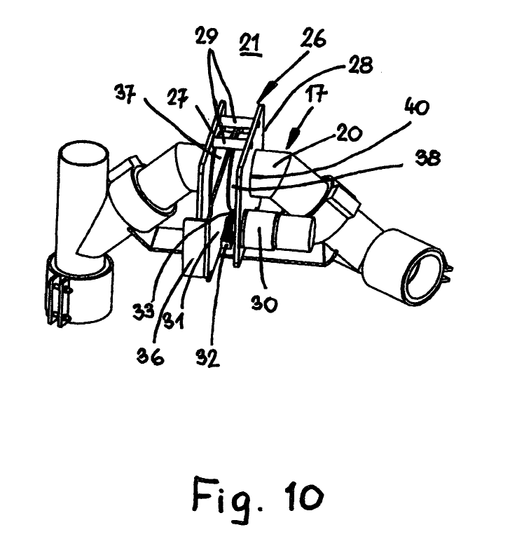

FIG. 10 in illustrations corresponding to FIGS. 2 to 5 a further embodiment of a coupling point with sender pipe part and receiver pipe part according to the invention;

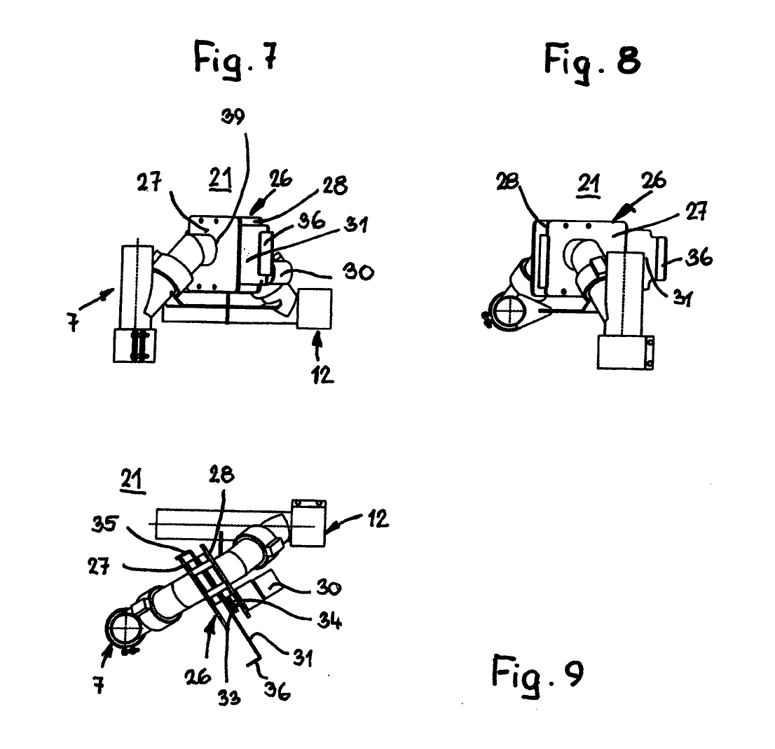

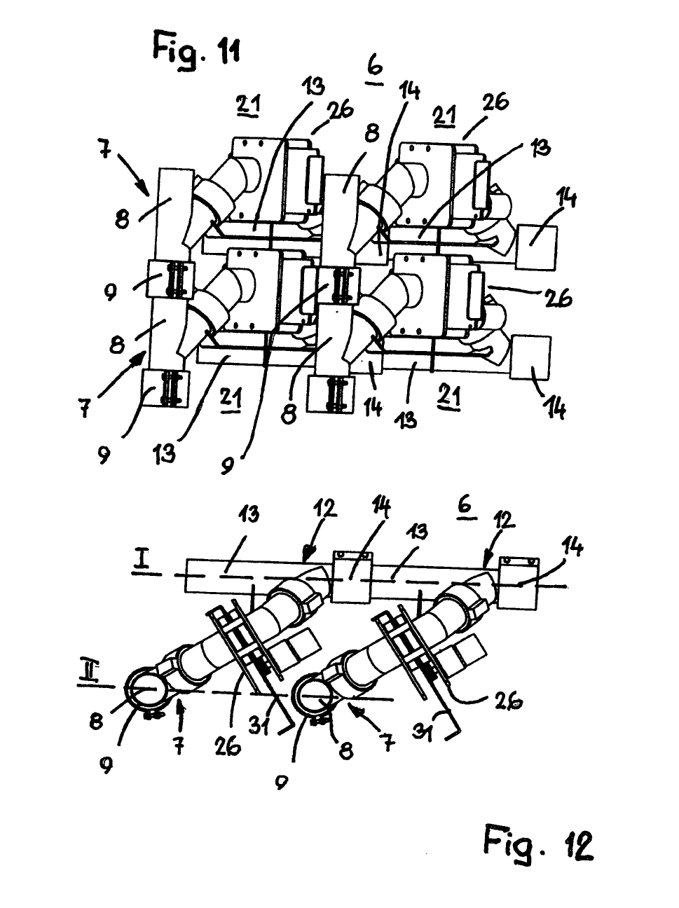

FIG. 11 a coupling station with four coupling points according to FIGS. 7 to 10 in side view;

FIG. 12 the coupling station according to FIG. 11 in plan view;

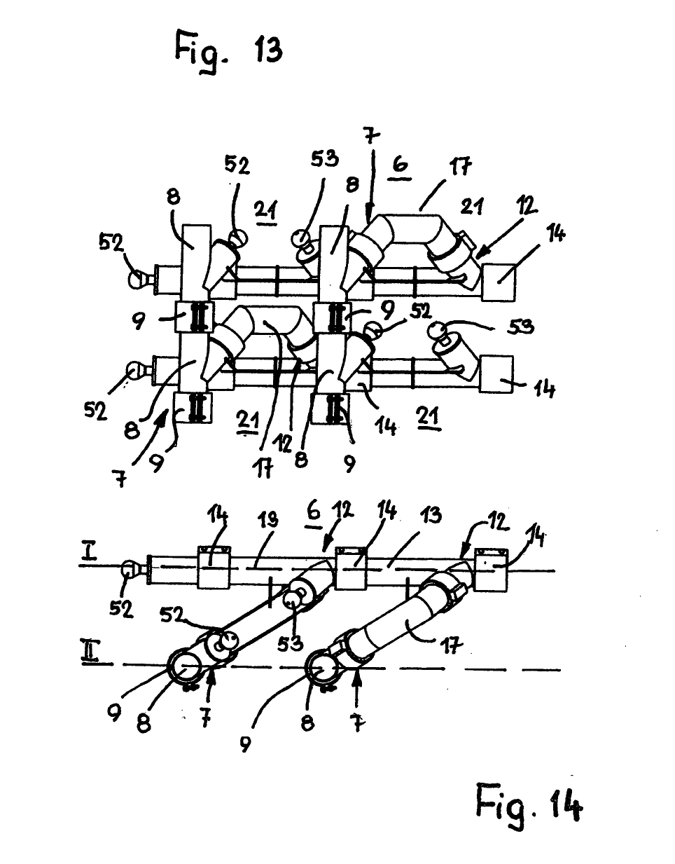

FIG. 13 a coupling station with four coupling points according to FIGS. 2 to 5 in side view, wherein two coupling points are open and two coupling points are closed;

FIG. 14 the coupling station according to FIG. 13 in plan view;

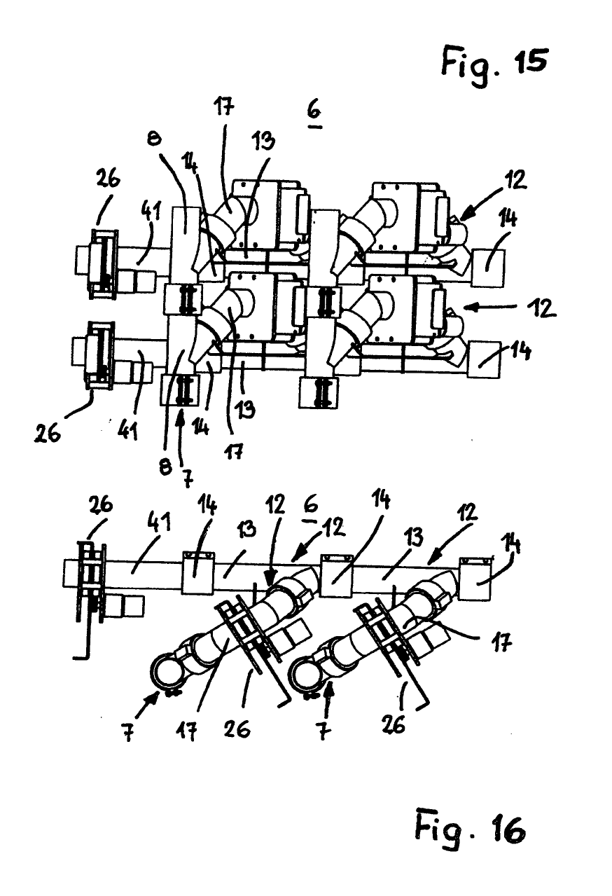

FIG. 15 in side view a further embodiment of a coupling station according to the invention with the sender pipe parts and receiver pipe parts according to FIGS. 7 to 10;

FIG. 16 the coupling station according to FIG. 15 in plan view;

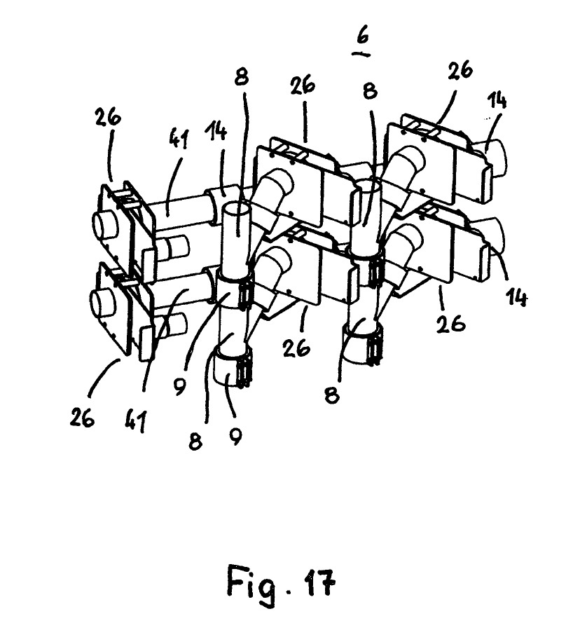

FIG. 17 the coupling station according to FIG. 15 in perspective illustration;

FIGS. 18a

to 18d a further embodiment of a coupling point according to the invention in different views;

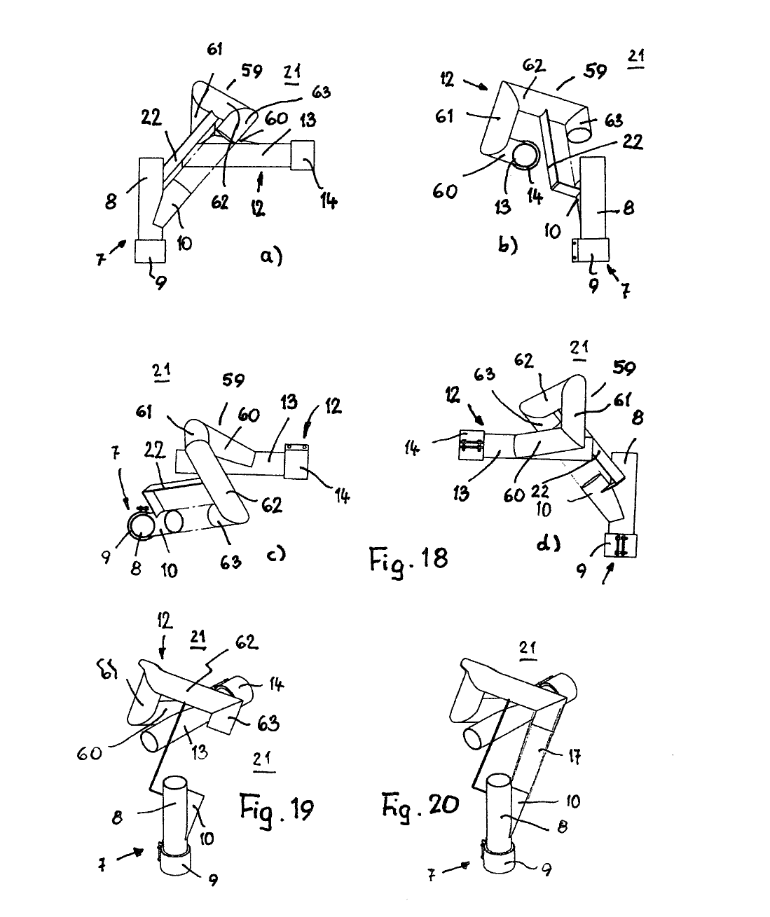

FIG. 19 the coupling point according to FIGS. 18a to 18d in closed position;

FIG. 20 the coupling point according to FIGS. 18a to 18d in conveying position.

FIG. 1 shows in schematic illustration a pneumatic vacuum conveyance system with which bulk material is transported from at least one storage container 1 to at least one consumer 2. In the embodiment, the vacuum conveyance system has three storage containers 1 in which the bulk material to be transported is stored. The storage containers 1 will be referred to in the following as senders.

The vacuum conveyance system is, for example, provided with four consumers 2 which in the following will be referred to as receivers. The consumers can be, for example, mixing or drying devices, processing machines, and the like. The senders 1 are silos that are provided with one or several vacuum device 3. They can be provided immediately at the senders 1 or can be positioned adjacent to the senders 1. Each sender 1 is connected fluidically with a sender pipe 4, respectively. The consumers 2, in turn, are connected fluidically with a receiver pipe 5, respectively. By means of the sender and receiver pipes 4, 5 the bulk material is transported from the respective sender 1 to the respective receiver 2. The sender pipes 4 and the receiver pipes 5 are connected to a coupling station 6. It comprises sender pipe parts and receiver pipe parts to be described from which the coupling station 6 is assembled. By means of the coupling station 6, the senders 1 can be connected for conveyance to each one of the receivers 2. In this way, the possibility exists to supply the bulk material contained in the respective sender 1 to one or several of the receivers 2. For conveying the bulk material, a vacuum source V is provided.

In FIG. 1, the coupling station 6 is schematically illustrated. At the coupling points that are identified by a circle, the sender pipe part and the receiver pipe part are connected to each other fluidically. At the other coupling points, no fluidic connection between the sender side and the receiver side exists. The senders 1 are identified by A, B, and C and the receivers 2 by 1 to 4. Since a fluidic connection between the sender side and receiver side exists only at the coupling points that are identified by a circle, in the illustration according to FIG. 1 the following situation results: the receiver 1 is connected for conveyance to the sender C, the receiver 2 to the sender B, the receiver 3 to the sender A, and the receiver 4 to the sender C. The coupling points of the coupling station 6 can be switched such that each sender A to C can be connected selectively for conveyance to each one of the receivers 1 to 4.

For forming the coupling points in the coupling station 6, sender pipe parts and receiver pipe parts are used which can be simply connected by a plug connection. The coupling station 6 can be expanded arbitrarily by means of the sender pipe parts and receiver pipe parts, also retrofitted, without requiring a constructive expenditure for this purpose or even a complete reconfiguration of the coupling station.

FIGS. 2 to 6 show a first embodiment of a sender pipe part and a receiver pipe part. The sender pipe part 7 comprises a straight pipe section 8 which, at one end, is provided with a coupling member 9. In the embodiment, it is a slidable coupling sleeve with which it is possible to connect the sender pipe part 7 to a further sender pipe part 7 within the coupling station 6 or to a corresponding sender pipe 4. A pipe section 10 branches off the pipe section 8 at an angle and, at the free end, is provided with a coupling member 11, preferably, a slidable coupling sleeve.

The receiver pipe part 12 has a straight pipe section 13 that is provided at its one end with a coupling member 14, preferably a slidable coupling sleeve. A pipe section 15 branches off at an angle from the pipe section 13 and is provided at its free end with a coupling member 16, preferably a slidable coupling sleeve.

The sender pipe part 7 and the receiver pipe part 12 are connected to each other by a connecting pipe 17. It is connected with its ends 18, 19 by means of the coupling members 11, 16 with the sender pipe part 7 and the receiver pipe part 12. Since the coupling members 11, 16 are designed advantageously as slidable coupling sleeves, the connecting pipe 17 can be connected by a simple plugging-in process with the sender pipe part 7 and the receiver pipe part 12. The coupling sleeves 11, 16 are designed like clamp collars and enable a simple pressure-tight connection between the sender pipe part 7 and the receiver pipe part 12 and the connecting pipe 17. Since the coupling members 11, 16 are provided at the free ends of the branched-off pipe sections 10, 15 which are converging toward each other in the installed position in the direction of their free ends, the ends 18, 19 of the connecting pipe 17 are angled relative to the center part 20 of the connecting pipe 17. The connecting pipe 17 can also be designed in an arc shape.

The branched-off pipe sections 10, 15 are positioned spatially displaced relative to each other so that the straight pipe sections 8 and 13 of the sender pipe part 7 and the receiver pipe part 12 extend at a right angle to each other in different planes. Advantageously, the pipe sections of the sender pipe part 7 and of the receiver pipe part 12 and the connecting pipe 17 have the same flow cross-section.

The sender pipe part 7, the receiver pipe part 12, and the connecting pipe 17 form a coupling point 21 of the coupling station 6.

The two branched-off pipe sections 10, 15 are supported relative to each other by at least one transverse web 22. It is advantageously plate-shaped and attached with angled ends 23, 24 to the exterior side of the branched-off pipe sections 10, 15 (FIG. 5). The ends 23, 24 are contacting the pipe sections 10, 15 about a portion of the circumference and are attached thereto in a suitable way, for example, by welding. In deviation from the illustrated embodiment, the transverse web 22 can have any suitable shape that ensures support and stiffening of the coupling point 21.

The pipe section 13 of the receiver pipe part 12 is supported by at least one further transverse web 25 on the transverse web 22. It extends substantially transverse to the transverse web 22 and is advantageously formed by a thin piece of sheet metal. It is attached about a portion of the circumference to the pipe section 13 and engages around the transverse web 22 at the top side and bottom side. The connection of the transverse web 25 with the pipe section 13 as well as with the transverse web 22 can be realized in any suitable way.

The coupling point 21 exhibits as a result of the transverse webs 22, 25 a high stiffness and ensures therefore a reliable operation. The coupling point 21 is of a compact configuration and requires only minimal installation space. The coupling point 21 forms a plug module that can be connected with additional coupling points 21 and/or with the sender pipes 4 or the receiver pipes 5 by a simple plug connection. The coupling members 9, 14 provided at one end of the straight pipe sections 8, 13 and advantageously designed as coupling sleeves enable a simple assembly and removal of the coupling point 21. All parts of the coupling point 21 are embodied to be shape-stable so that a safe handling upon assembly of the coupling station 6 is ensured.

The connecting pipe 17 is detachably connected with the sender pipe part 7 and the receiver pipe part 12. When the coupling point 21 is to be open for passage of material, the connecting pipe 17 is inserted (FIG. 5). When the coupling point 21 is however to be closed, the connecting pipe 17 is removed. Instead, into the two branched-off pipe sections 10, 15 closure parts 52, 53 are inserted (FIG. 6). They have a cover 54, 55 with a handle 56, 57 with which the closure parts 52, 53 can be inserted and removed in a simple way. They project with (non-illustrated) spring elements into the pipe sections 10, 15. The spring elements are elastically deformed upon insertion into the pipe sections 10, 15 and are contacting with a satisfactorily high spring force the inner wall of the pipe sections 10, 15. The closure parts 52, 53 close off the pipe sections 10, 15 seal-tightly. Advantageously, the closure parts 52, 53 are connected by securing elements, for example, chains, cables, and the like, with the sender pipe part 7 or receiver pipe part 7. Accordingly, the closure parts 52, 53 are accessible any time they are needed.

FIGS. 7 through 10 show a coupling point 21 which in principle is of the same configuration as the preceding embodiment. It differs from it in that at the connecting pipe 17 a closure device 26 is provided with which the passage for the bulk material can be opened or closed. The closure device 26 is arranged at the center part 20 of the connecting pipe 17 and has two parallel positioned plates 27, 28 that are positioned parallel to each other and between which spacers 29 are positioned. At the exterior side of one plate 28 a drive motor 30 is provided which is advantageously an electric motor and with which a closure plate 31 can be moved. It is positioned in the area between the two plates 27, 28 and carries on one side the toothed rack 32 engaged by a pinion 33. It is seated fixedly on a drive shaft 34 of the drive motor 30 that penetrates the plate 28.

The closure plate 31 has an angular, in the embodiment rectangular, contour. Both ends 35, 36 of the closure plate 31 are angled, preferably at a right angle. As can be seen in FIG. 9, the angled ends 35, 36 serves as stops with which the travel stroke of the closure plate 31 can be limited. Depending on the position of the closure plate 31, the first end or the second end is resting on the plate 27. The stop position is used advantageously for switching off the drive motor 30 upon adjustment of the closure plate 31 from the closed into the open position, and vice versa. However, it is also possible to control the drive motor 30 such that the closure plate 31 can be displaced by the desired amount between the open position and the closed position. The stops for the closure plate are not required then.

The closure plate 31 is provided with an opening (not illustrated) whose opening width corresponds to the opening width of the connecting pipe 17. In the position illustrated in FIGS. 7 to 10, the closure plate 31 is in its open position so that the bulk material to be conveyed can flow from the sender pipe part 7 via the connecting pipe 17 to the receiver pipe part 12.

The angled ends 35, 36 can also serve as handles in case the drive motor 30 malfunctions; then, the closure plate 31 can be moved by hand between the closed position and the open position. The closure plate 31 can be moved with the angled ends 35, 36 also in case the closure plate 31 is not moved motorically but manually. In such cases, a drive motor is not present.

The closure plate 31 is positioned between two annular disks 37, 38 (FIG. 10) that are comprised of elastic material, preferably rubber, which are fastened at facing inner sides of the two plates 27, 28. The closure plate 31 is seal-tightly arranged between the two annular disks 37, 38.

The center part 20 of the connecting pipe 17 is divided so that the closure device 26 can be installed into the center part 20. The two plates 27, 28 that project on all sides past the center part 20 each are provided with an opening 39, 40 (FIGS. 7 and 10) in which the two ends of the divided center part 20 are inserted. The ends of the center part 20 are connected medium-tightly with the closure device 26 so that the bulk material flow from the sender 1 to the receiver 2 across the coupling point 21 is undisturbed.

In another embodiment (not illustrated), at the exterior sides of the plates 27, 28 that are facing away from each other coupling members are provided, preferably slidable coupling sleeves, into which the ends of the divided center part 20 are inserted. The coupling sleeves are designed also like clamp collars. By means of the coupling members a medium-tight connection between the coupling members and the ends of the divided center part 20 is possible in a simple way.

The use of coupling sleeves has the advantage that the connection is detachable so that, as needed, the closure device 26 can be easily exchanged.

The closure device 26 forms an independent component which is integrated into the coupling point 21. The connection between the sender pipe part 7 and the receiver pipe part 12 is realized by a simple plugging-in process. In the assembled state, the coupling point 21 with the integrated closure device 26 forms a compact, shape-stable plug module that, in a simple way, can be connected with additional coupling points 21 or with the sender pipes 4 or the receiver pipes 5.

One example of a coupling station 6 with the coupling points 21 according to

FIGS. 7 to 10 is shown in FIGS. 11 and 12. The coupling station 6 is formed in an exemplary fashion of four coupling points 21 that are plug-connected with each other in a medium-tight way. The coupling points 21 are arranged adjacent and above each other. The pipe sections 8 of the sender pipe parts 7 are plugged together and, by means of the coupling members 9, are connected to each other in a medium-tight way. The pipe sections 13 of the receiver pipe parts 12 are also plugged together and connected with each other by the coupling members 14 in a medium-tight way. As is apparent from FIG. 12, the axes of the straight pipe sections 13 of the receiver pipe parts 12 are positioned in a common plane I. The axes of the pipe sections 8 of the sender pipe parts are positioned also in a common plane II, wherein the axes of the pipe sections 8 of the sender pipe parts 7 are positioned perpendicular to the axes of the pipe sections 13 of the receiver pipe parts 12.

The spacing between the two planes I and II corresponds advantageously at least to the diameter of the pipe sections 8 and 13, preferably a multiple of the diameter. Accordingly, the coupling station 6 requires only minimal installation space. Since the pipe sections 8, 13 of the sender pipe parts 7 and the receiver pipe parts 12 are positioned in separate planes I and II, a simple assembly and removal of the coupling points 21 is possible also. The coupling station 6 can be expanded, as needed, by simple plugging-in processes. Also, removal of individual coupling points 21 is possible easily.

The spacing between the planes is selected such that the closure devices 26 can be accommodated also in a space-saving way in the coupling station 6. The dimensions of the coupling points 21 are designed such that the closure devices 26 are located substantially in the area between the two planes I and II. The closure plates 31 are positioned angularly relative to the planes I, II, viewed in axial direction of the pipe sections 8 (FIG. 14).

The coupling stations 6 (FIGS. 11, 12) comprise in an exemplary fashion four coupling points 21. Additional coupling points 21 can be attached in the described way to the already existing coupling points 21 by means of the respective coupling members 9, 14. The coupling station 6 can thus be expanded to the desired extent in a simple way by plugging-in processes. On the other hand, it is also possible to reduce the number of coupling points 21 within the coupling station 6 should this be necessary. Within the coupling station 6, the coupling points 21 are easily accessible so that, for example, repair work can be performed without problems.

FIGS. 13 and 14 show a coupling station 6 which is comprised in an exemplary fashion of four coupling points 21 positioned adjacent and above each other which are embodied in accordance with the embodiment of FIGS. 2 to 6. The pipe sections 8 of the coupling points 21 positioned above each other are plugged together and connected to each other by means of the coupling members 9 in a medium-tight way. In the same way, also the pipe sections 13 of the receiver pipe parts 12 are connected to each other by means of the coupling members 14 in a medium-tight way.

As can be seen in FIG. 14, the axes of the straight pipe sections 13 are in a common plane I and the axes of the pipe sections 8 of the sender pipe parts 7 in a common plane II, wherein the axes of the pipe sections 8 are positioned perpendicularly to the axes of the pipe sections 13. As in the embodiment according to FIGS. 11 and 12, the planes I and II are parallel to each other. The spacing between the planes I and II corresponds advantageously at least approximately to the outer diameter of the pipe sections 8 or 13, advantageously to a multiple of the diameter, so that the coupling station 6 requires only minimal installation space. With the exception of the closure members 52 and 53, the coupling station 6 is of the same configuration as the embodiment according to FIGS. 11 and 12.

The end of the pipe conduit formed by the pipe sections 13 that is to the left in FIGS. 13, 14 is closed off by closure member 52.

At the left upper and right lower coupling points 21, the connecting pipes 17 are removed and the closure members 52, 53 inserted. The material can thus only flow through the left lower and the right upper coupling point 21 from the sender pipe part 7 to the receiver pipe part 12.

This coupling station 6 is provided for manual operation. Depending on the situations of use, the required coupling members 21 are opened for passage by inserting the connecting pipe 17 or are blocked by removing the connecting pipe 17 and inserting the closure members 52, 53.

FIGS. 15 to 17 show the coupling station 6 according to FIGS. 11 and 12 in which pipes 41 are connected to the left pipe sections 13 of the receiver pipe parts 12; they extend straight and are connected by coupling members 14 with the pipe sections 13 of the receiver pipe parts 12 in a medium-tight way.

The pipes 41 have the same cross-section as the pipe sections 13 and are provided at their free end with a closure device 26 which is of the same design as the closure devices 26 in the connecting pipes 17. With the closure devices 26, the pipe conduits that are formed of the pipe sections 13 can be closed. Since the closure devices 26 of the pipes 41 are of the same configuration as the closure devices 26 in the connecting pipes 17, they are not described in more detail.

In use of the coupling station 6, the closure devices 26 of the pipes 41 are in closed position. While in the embodiment according to FIGS. 13 and 14 the respective coupling members 21 are manually opened and blocked, in the coupling station 6 according to FIGS. 15 and 16, the closure devices 26 are actuated in order to displace the closure plate 31 into the closed position or into the open position. Depending on to which receivers 2 the bulk material from the senders 1 is to be transported, the appropriate closure devices 26 of the connecting pipes 17 are opened or closed, as has been explained in an exemplary fashion with the aid of FIG. 1. The closure devices 26 of the terminal pipes 41 are closed so that no foreign air can be sucked in during conveyance.

FIGS. 18a to 18d show a further embodiment of a coupling point 21. It is provided with the sender pipe part 7 with the straight pipe section 8 which is provided at one end with coupling member 9. It is a slidable coupling sleeve with which the sender pipe part 7 can be connected to a further sender pipe part 7 within the coupling station 6 or to the corresponding sender pipe 4. From the pipe section 8 the pipe section 10 branches off at an angle which, similar to the embodiment according to FIGS. 5 and 6, is positioned in an exemplary fashion at an angle of approximately 50° relative to the pipe section 8.

The receiver pipe part 12 comprises the straight pipe section 13 which is provided at one end with the coupling member 14 that advantageously is a slidable coupling sleeve. In contrast to the embodiment according to FIGS. 5 and 6, no straight pipe section is extending at an angle away from the pipe section 13 but a connecting pipe member 59 that is angled several times. It is angled such that the bulk material as it passes through the coupling point 21 is subjected to a total deflection of more than approximately 270°. The connecting pipe member 59 comprises a straight pipe section 60 adjoining at an angle the pipe section 13. At the free end of the pipe section 60, a pipe section 61 adjoins at a right angle that, in turn, adjoins at a right angle a pipe section 62. It passes, in turn, at a right angle into a terminal pipe section 63.

The individual pipe section 60 to 63 are not positioned in a common plane but are each displaced relative to each other so as to be arranged in different planes, as can be seen in FIGS. 18a to 18d. Reference is being had expressly to the illustration in FIGS. 18a to 18d with regard to the extension of the pipe sections 60 to 63. The longitudinal axes of the pipe section 60 to 63 each are angularly arranged relative to each other in space. Also, the axes of the pipe sections 60 to 63 are positioned at an angle relative to the axis of the straight pipe section 13.

The pipe sections 60 to 63 are arranged angularly relative to each other in such a way that the angled pipe section 63 of the receiver pipe part 12 is aligned with the pipe section 10 of the sender pipe part 7.

The sender pipe part 7 and the receiver pipe part 12 are supported relative to each other by the transverse web 22. It is fastened with one end to the exterior side of the pipe section 62 of the receiver pipe part 12 and with the other end to the exterior side of the pipe section 12 of the sender pipe part 7. As has been explained in connection with the embodiment according to FIGS. 5 and 6, the ends of the transverse web 22 are advantageously welded to the appropriate pipe sections. In other respects, this embodiment is of the same configuration as the embodiment according to FIGS. 5 and 6.

FIG. 19 shows the coupling point 21 when no bulk material is to be conveyed therethrough. Then, the pipe section 63 and the pipe section 10 are not connected to each other. As has been explained in connection with the embodiment according to FIGS. 5 and 6, the free ends of the pipe sections 10 and 63 are closed by appropriate closure members. They seal-tightly close off the pipe sections. In FIG. 19, these closure members are not illustrated for simplifying the representation.

When bulk material is to be transported through the coupling point 21, the closure members are removed and instead the connecting pipe 17 is inserted into the ends of the two pipe sections 10, 63 (FIG. 20). Since the two pipe sections 10, 63 of the sender pipe part 7 and the receiver pipe part 12 are aligned with each other, the connecting pipe 17 can be inserted easily.

The multiple deflection action on the bulk material during its transport through the coupling point 21 and the deflection achieved thereby by more than 270°, in the illustrated embodiment approximately 330°, is primarily advantageous when several receivers 2 are connected to the same sender 1 and, for example, the bulk material 44 is sucked in by one of these receivers 2. The described strong deflection ensures that bulk material is never accidentally sucked in via the sender pipe parts 7 and their pipe sections 10 by means of the connecting pipe member 59 toward the receiver pipe parts 12 of the other receivers 2 connected to this sender 1 but not sucking in bulk material.

The described coupling station 6 is comprised in the simplest case of two parallel extending receiver pipes 5 with at least two inlets 15 each in the form of branched-off pipe sections 15. They are fluidically connected by the connecting pipes 17 or the open closure devices with the branched-off pipe sections 10 of the sender pipe parts 7 and form the coupling points 21. The plugged-in pipe sections 8 of the sender pipe parts 7 each form a pipe conduit that is connected with the sender pipes 4 that form distribution pipes (FIG. 1). The upper ends of these pipe conduits are closed by removable closures 58 (FIG. 1). When the coupling station 6 is to be expanded, the closures 58 are removed so that a further coupling point 21 can be connected.

The pipe conduits of the coupling station 6 formed by the pipe sections 13 are closed at the left end by the closure members 52 or the closure devices 26. The respective pipe conduit is then opened when another material is to be conveyed through the pipe conduit to the respective receiver 2. In the embodiment according to FIG. 1, the receiver 4 is, for example, connected with the sender C. When, for example, material is to be supplied from the sender B to the receiver 4, emptying by vacuum action is performed first. For this purpose, the appropriate upper pipe conduit of the coupling section 6 is opened by removal of the left closure 57 or by opening the closure device 26 arranged thereat. By emptying by vacuum action, residual quantities of the prior bulk material (from sender C) still present in the pipe conduit and in the adjoining receiver pipe 5 are removed. After emptying by vacuum action, the corresponding horizontal pipe conduit is closed again. Then, after closure of the left upper coupling point 21 and opening of the right adjacently positioned coupling point 21, the bulk material can be supplied from the sender B to the receiver 4.

The coupling points 21 have advantageously the property that the spatial distance of the respective outlet 10 of the sender pipe parts 7 in relation to the respective inlet 15 of the receiver pipe parts 12 is always the same.

The described closure device 26 represents a preferred embodiment. The two annular disks 37, 38 are comprised of an elastic material, preferably of rubber. The two annular disks take over the function of a closure of the two plates 27, 28 by utilizing the vacuum in the pipe conduit. Switching of the closure device 26 causing the closure plate 31 to be displaced, is carried out in the pressureless state, i.e., no vacuum is existing in the sender pipe part 7 and in the receiver pipe part 12.

The closure device 26 can also have any other suitable configuration with which it is ensured that the respective passage for the bulk material 44 can be opened or closed. For example, instead of a slidable closure plate 31 a rotary part can be used. It is provided with a through opening which enables in one position passage of the air flow 43 with the bulk material 44. In another rotary position of the rotary part, the passage cross-section is closed off.

The closure devices 26 are provided in the connecting pipes 17. Therefore, they come into contact with the bulk material 44 only when it is flowing through the open connecting pipe 17. When the connecting pipe 17 is blocked by the closure device 26, the bulk material does not flow through these connecting pipes 17 but only through the pipe sections 8 of the sender pipe parts 7. Therefore, the closure device 26 is subjected to only minimal wear.

The crossing pipe sections 8 and 13 of the sender pipe parts 7 and of the receiver pipe parts 12 are positioned in the adjacently arranged planes I and II that are parallel to each other so that the axes of the pipe sections 8, 13 have a favorable spacing relative to each other. This spacing corresponds advantageously at least approximately to the outer diameter of the pipe sections 8 and 13, preferably to a multiple of the outer diameter. The coupling station 6 is comprised of the fixedly installed pipe sections 8 and 13 that are fixedly connected to each other. By opening the corresponding closure device 26, the bulk material can be supplied in a targeted fashion from the sender side 1 to any of the receivers 2. The coupling points 21 form plug modules that at the same time comprise the sender pipe part 7 and the receiver pipe part 12 wherein the closure device 26 is advantageously arranged in the connecting pipe section 17 connecting these two pipe parts. By plugging together the coupling points 21, the pipe conduits 8 and 13 are formed which are part of the sender pipes 4 as well as of the receiver pipes 5. The pipe sections 8 of the sender pipe parts 7 extend preferably vertically while the pipe sections 13 of the receiver pipe parts 12 advantageously extend horizontally. The plug modules 21 enable a simple configuration of the respectively required coupling station 6. The coupling points 21 are plugged together in such a way that the bulk material is conveyed from the senders 1 at a slant upwardly in the branched-off pipe sections 10 while in the branched-off pipe sections 15 it is conveyed at a slant downwardly into the horizontal pipe sections 13 and from there to the respective receivers 2. In this way, deposits at the sender side and the receiver side are avoided.

In the simplest case, the plug modules 21 are comprised substantially of a sender pipe part 7 and a receiver pipe part 12 with the corresponding webs 22, 25. A plug module can however also be formed in that two or more described plug modules 21 are combined to a unit. For example, in Fig. lithe two upper and the two lower coupling points 21 each can be combined to a single plug module so that only one plugging-in process is required in order to assemble the two plug modules to the coupling station 6.

Also, in an exemplary fashion, all four coupling points 21 of FIG. 11 can be combined to a single plug module.

The pneumatic conveyance system can be operated with pressure instead of with vacuum.

What is claimed is:

1.-18. (canceled)

19. A coupling point for forming a coupling station between at least two senders and at least one receiver of a pneumatic conveyance system for conveying bulk material, wherein the pneumatic conveyance system comprises sender pipes and receiver pipes fluidically connecting the at least two senders and the at least one receiver with the coupling station, the coupling point comprising:
a plug module comprising at least one sender pipe part and at least one receiver pipe part;
wherein the at least one sender pipe part comprises at least one outlet for the bulk material and further comprises at least one first connector configured to connect to a further plug module or to a sender pipe;
wherein the at least one receiver pipe part comprises at least one inlet for the bulk material and further comprises at least one second connector configured to connect to a further plug module or to a receiver pipe;
wherein the outlet of the at least one sender pipe part and the inlet of the at least one receiver pipe part are configured to be closable or openable.

20. The coupling point according to claim 19, wherein the outlet of the at least one sender pipe part and the inlet of the at least one receiver pipe part are positioned oppositely slanted relative to each other such that the outlet in a flow direction of the bulk material extends at a slant upwardly and at least one part of the inlet in the flow direction of the bulk material extends at a slant downwardly.

21. The coupling point according to claim 19, wherein the outlet branches off a pipe section of the at least one sender pipe part and wherein the inlet branches of a pipe section of the at least one receiver pipe part.

22. The coupling point according to claim 21, wherein the at least one first connector is provided at least at one end of the pipe section of the at least one sender pipe part and wherein the at least one second connector is provided at least at one end of the pipe section of the at least one receiver pipe part.

23. The coupling point according to claim 19, wherein the at least one first connector and the at least one second connector are slidable coupling sleeves.

24. The coupling point according to claim 19, further comprising at least one support, wherein the at least one sender pipe part and the at least one receiver pipe part are supported relative to each other by the at least one support.

25. The coupling point according to claim 19, further comprising a connecting pipe, wherein the outlet of the at least one sender pipe part is connected to the inlet of the at least one receiver pipe part by the connecting pipe.

26. The coupling point according to claim 25, wherein the connecting pipe comprises a center part and pipe ends connected to opposite ends of the center part and extending slantedly away from the center part.

27. The coupling point according to claim 26, wherein the pipe ends of the connecting pipe extend in a common plane.

28. The coupling point according to claim 25, further comprising a closure device provided in the area of the connecting pipe and configured to open or close the connecting pipe.

29. The coupling point according to claim 19, wherein the outlet branches off a pipe section of the at least one sender pipe part and wherein the inlet branches of a pipe section of the at least one receiver pipe part, wherein an axis of the pipe section of the at least one sender pipe part and an axis of the pipe section of the at least one receiver pipe part are positioned in different planes, respectively.

30. The coupling point according to claim 29, wherein the different planes extend parallel to each other.

31. The coupling point according to claim 29, wherein a spacing between the different planes corresponds at least to a diameter of the pipe section of the at least one sender pipe part or of the pipe section of the at least one receiver pipe part.

32. The coupling point according to claim 31, wherein the spacing is a multiple of said diameter.

33. The coupling point according to claim 29, further comprising a connecting pipe, wherein the outlet of the at least one sender pipe part is connected to the inlet of the at least one receiver pipe part by the connecting pipe, wherein the connecting pipe extends at a slant relative to the different planes.

34. The coupling point according to claim 29, wherein the pipe section of the at least one sender pipe part and the pipe section of the at least one receiver pipe part are positioned perpendicularly to each other.

35. The coupling point according to claim 29, wherein a pipe configuration connecting the at least one sender pipe part to the at least one receiver pipe part comprises deflections that in total amount to at least 270°.

36. The coupling point according to claim 35, wherein the inlet of the at least one receiver pipe part comprises pipe sections that adjoin each other at an angle, respectively.

37. A coupling station arranged between at least two senders and at least one receiver, wherein sender pipes and receiver pipes connect fluidically the at least two senders and the at least one receiver to the coupling station, the coupling station comprising at least two shape-stable plug modules each comprising at least one sender pipe part and at least one receiver pipe part fluidically connected or connectable to each other.

38. The coupling station according to claim 37, wherein the plug modules each are a plug module according to claim 19.
